(19) United States
(12) Patent Application Publication
(10) Pub. No.: US 2005/0037501 A1
(43) Pub. Date: Feb. 17, 2005

(54) Test kit for simultaneously detecting several types of residues

(75) Inventors: Bernhard Meyer, Mettmann (DE); Thomas Tyborski, Duesseldorf (DE)

Correspondence Address: ECOLAB INC., 840 SIBLEY MEMORIAL HIGHWAY, MENDOTA HEIGHTS, MN, 55118, US

(73) Assignee: ECOLAB INC.

(21) Appl. No.: 10/416,355

(22) PCT Filed: Oct. 31, 2001
(86) PCT No.: PCT/EP01/12636

(30) Foreign Application Priority Data
Nov. 9, 2000 (DE) 100 55 557.8

(51) Int. Cl. G01N 31/00

(52) U.S. Cl. 436/5

(57) ABSTRACT

Process for differentiating the nature of residues on hard surfaces. The invention furthermore relates to the use of the process according to the invention for monitoring residues in the foodstuffs, pharmaceuticals or cosmetics industry and in food-processing facilities. The invention also relates to articles for the simultaneous detection of at least two different types of residues, which articles are equipped with one or more adsorbents suitable for absorbing residues.

The present invention relates to a process for differentiating the nature of residues on hard surfaces. The invention furthermore relates to the use of the process according to the invention for monitoring residues in the foodstuffs, pharmaceuticals or cosmetics industries and in food-processing facilities. The invention also relates to articles for the simultaneous detection of at least two different types of residues, which articles are equipped with one or more adsorbents suitable for absorbing residues.

The production or processing of foodstuffs or other materials which contain organic components of animal or vegetable origin gives rise to soiling of equipment, work surfaces and premises. Such soiling may result in the formation and growth of bacteria, fungi and microorganisms. Since this may have a considerable influence upon the quality of the products processed and must accordingly be avoided, a high level of hygiene is required.

Regular cleaning and disinfection is indispensable if a high level of hygiene is to be achieved in a foodstuffs manufacturing plant. Organic residues, such as proteins, fats, low and high molecular weight carbohydrates, which are usually simultaneously present, are generally encountered in a foodstuffs plant, in addition to inorganic residues.

Cleaning agents of varying composition are used to remove such soiling. Selection of the suitable cleaning agent is generally made on the basis of the type of soiling to be removed. If the type of soiling is known, the cleaning agent may be selected accordingly. However, the varying combinations of cleaning agent components result in differing cleaning performance for protein, fat and carbohydrates. Under certain circumstances, small residues of soil may remain after a cleaning operation which, while mainly invisible to the naked eye, still constitute a microbiological risk.

Until now, hygiene status has frequently been verified by bacteriological methods by preparing a culture. However, such methods for verifying hygiene status are unsuitable because they can only be used to determine living organisms (bacteria and fungi). It is not possible using bacteriological methods to detect the organic contamination which gave rise to the bacterial growth. It is thus not possible directly to determine the success of cleaning by bacteriological methods. Bacteriological methods are furthermore time-consuming and it may take several hours, if not even days, for a definitive result to be available.

Monitoring of hygiene by bacteriological methods may furthermore be distorted by disinfection which does not exclude the accumulation of organic contaminants, which are ultimately the cause of the growth of resistant microorganisms. Furthermore, it is not possible by isolated sampling to guarantee that the hygiene status of entire pieces of equipment and relatively large surfaces may be verified.

PCT publication WO 90/14591 describes a process for cleaning and simultaneously monitoring the success of cleaning and hygiene by application of a solution of a mixture of a cleaning agent and a dye or dye combination onto surfaces to be cleaned. The organic contamination which remains on the surface after cleaning is dyed and so rendered visible. By using this method, however, it is only possible to establish whether residues remain on the surface after cleaning. It is not possible to make any statement with regard to the nature of the residues, i.e. whether they comprise fats, carbohydrates of proteins, on the basis of this method.

EP-A-0 347 494 describes a process for the detection of contamination on an article by the treatment thereof with a dye solution and subsequent reaction with a developer solution. In this case too, it is only possible to locate the contamination, but not to differentiate it by type.

U.S. Pat No. 4,745,797 describes a process for determining leakage of organic material from containers or lines.

It is known from dentistry to dye foodstuff residues with indicators (erythrosine). In this case, the indicators are used to reveal dental plaque. In this case too, it is only possible to state that there are food residues on the teeth.

Granted European patent EP 715 713 B1 discloses a process which makes it possible, after a cleaning operation, to determine which type of organic residues are on the surface, in order to be able purposefully to use specific cleaning agents for any possibly required recleaning or in order to be able to use suitable cleaning agents or combinations of cleaning agents in future and thus avoid recleaning.

EP 715 713 B1 similarly discloses how to identify the type of organic surface residues before the actual cleaning operation, so that a suitable cleaning agent may be used directly.

This requirement for a rapid method for determining organic soil residues before or after a cleaning operation applies not only to the entire foodstuffs manufacturing industry, but also to any sectors in which cleaning is required on hygiene and/or aesthetic grounds, such as in particular the meat, fish, delicatessen, beverage trades, breweries, milk-processing and agricultural facilities, the starch and sugar industry, kitchens, hospitals, swimming pools, cosmetics industry and pharmaceuticals industry.

EP 715 713 B1 attempts to satisfy this requirement by disclosing a process for differentiating organic foodstuff residues, in which, by application of a solution containing a combination of at least two dyes, at least one of which is of a hydrophilic nature and at least one of which is of a hydrophobic nature, onto the hard surface, and subsequent optical determination, it is possible to identify the type of residue by the specific colour thereof.

In practical use, however, a problem occurs in some instances which is mentioned in EP 715 713 B1 itself on page 10, line 55, where it is stated that, in the presence of a mixture of fat, protein and carbohydrates, mixed colours may occur, wherein one or another colour dominates as a function of the quantity ratio of the food residues present. In practice, however, it has been found that in particular stronger colours, such as blue, brown or black, overwhelm weaker colours such as yellow, such that it is then no longer possible to differentiate between various types of residue. Another problem which is not mentioned in EP 715 713 B1 is that, due to the application of a dye combination and subsequent reaction with the residues, a dye/residue complex may form which, depending upon its type and concentration, may itself constitute a cleaning problem.

It was accordingly the object of the present invention to provide a process which makes it possible to differentiate the type of organic contamination on hard surfaces before or after a cleaning operation, i.e. to differentiate between fat, protein and carbohydrate (low and high molecular weight). The process should be simple to perform and permit differentiation of the contamination into fat, protein or carbohydrate, without there being any impairment of the determination of one type of residue by the determination of the other types of residue. It should also be possible to perform the process in such a manner that the formation of sparingly soluble residues on the hard surfaces is, as far as possible, avoided.

This object is achieved according to the invention by a process for the simultaneous detection of at least two different types of residue on hard surfaces, in which an article, which is equipped with one or more adsorbents suitable for accepting residues, is brought into contact with the surface to be investigated, wherein
a) the adsorbent or adsorbents contain(s) chemical substances which are capable of entering into a visually discernible colour reaction with various residues, which reaction permits qualitative assignment to a particular type of residue, wherein the chemical substance is preferably bound to the residue substrates by chemical reaction or physical interaction, or
b) after adsorption of the residue, chemical substances are applied onto the adsorbent or adsorbents, which chemical substances are capable of entering into a visually discernible colour reaction, which reaction permits qualitative assignment to a particular type of residue, wherein the chemical substances are applied manually or preferably automatically with a simple device onto the adsorbent or adsorbents.

In a preferred embodiment of the process according to the invention, the types of residues simultaneously detected are organic residues selected from among fats, proteins and/or carbohydrates.

It is furthermore preferred that the colour reaction is accelerated by an increase in temperature.

In the process according to the invention, the chemical substances entering into a colour reaction are preferably selected from among ninhydrin, Coomassie blue, Folin reagent, biuret reagent, a-naphthol, diphenylamine, aniline, iodine, lipase and fluorescent dyes, such as 2′, 7′-dichlorofluorescein, erythrosine, Ponceau 4R, curcumin, β-carotene, riboflavin and Ceres Blue RR or mixtures thereof.

The adsorbent or adsorbents present according to the process according to the invention preferably consist(s) of solid polymeric material with absorbency, wherein it is particularly preferred that the polymeric material is selected from among wool, silk, polyacrylic, viscose, polyamide, polyacetate, lyocell.

It is furthermore preferred in the process according to the invention that the article present in the process according to the invention is equipped with one or more identical or different adsorbents in such a manner that at least two separate areas of the adsorbents are visually distinguishable. Differentiation may be achieved, for example, by spatial separation or by other colours or by perforation at the interface or other conceivable delimiting features.

On performance of the process according to the invention, it is preferred to moisten the adsorbent or adsorbents before adsorption of the residue, wherein moistening is particularly preferably performed with water or organic solvent.

The process according to the invention is preferably performed in such a manner that the qualitative detection of at least two types of residue is simultaneously possible.

As already mentioned, the organic residues preferably comprise fats, proteins and/or carbohydrates which may be present simultaneously or individually.

Using this process, it is possible, without risking the formation of difficult to remove dye complexes on the surface to be cleaned, for the user
1. to identify the type of organic contamination before the actual cleaning, such that the type of cleaning agent may be selected,
2. to monitor the success of cleaning with regard to various types of residue once cleaning has been performed,
3. easily to identify the weaknesses of his/her cleaning agent with regard to the individual soil components, such that the correct cleaning agent may be selected in future, and,
4. once the organic residues remaining after a cleaning operation have been identified, to remove such residues with special cleaners.

The process according to the invention is also a simple method for determining the qualitative and optionally quantitative cleaning performance of cleaning preparations during development of a cleaning preparation, by, during testing of such a preparation, bringing test soiling (fat/protein/starch) into contact first with the cleaning preparation to be investigated and then into contact with the article to used in accordance with the process according to the invention, wherein the article is optionally further treated in accordance with the above description. Thanks to the differing discolouration due to the individual soil components, it is possible to identify which component is detached by the cleaning preparation to a greater or lesser extent. More purposeful improvements to the formulation may then be made.

The process according to the invention also makes it possible to select a suitable cleaning preparation before cleaning by detecting the type of soiling. After cleaning, it is possible, on the one hand, to monitor the success of cleaning and, on the other, to select suitable special cleaning agents for the soil component which has not been removed. When cleaning large production plants or facilities it is, for example, possible to define critical points in accordance with the HACCP procedure (Hazard Analysis Critical Control Points). After cleaning, the process according to the invention is performed at these critical points and suitable action is taken depending upon the result.

Adsorption of the residues to be determined from the hard surface to be investigated may proceed in known manner, but in particular by blotting or wiping from the surface to be investigated.

The following is a list by way of example of chemical substances which may be used for the purposes of the present invention, which substances, once the residues have been adsorbed, are capable of entering into a visually discernible colour reaction with residues. Reference is made to the following standard publications with regard to the details relating to “Colour Index number C.I.”, “DFG name”, “synonyms” and “EC number”:
“Kosmetische Färbemittel” [=cosmetic colorants], 3^{rd} edition, 1991, published by Farbstoffkommission [=dyes committee] of Deutsche Forschungsgemeinschaft (DFG) [=German National Research Council], VCH Verlagsgesellschaft mbH, and

“Colour Index”, third edition, vols. 1-9, published by The Society of Dyers and Colourists.

| Colour | | | |
|---|---|---|---|
| index | | | EC |
| C.I. | DFG Name | Synonyms | number |
| 10020 | C-ext. Grün 6 | Naphthol Green B, L-extr. Green 1 | — |
| 13015 | C-Gelb 9 | Fast Yellow | — |
| 14270 | C-Gelb 12 | Chrysoin S | — |
| 14700 | C-Rot 57 | Ponceau SX, FD&C Red 4 | — |
| 14720 | C-Rot 54 | Azorubine, Carmoisine, L-Red 1 | E 122 |
| 14815 | C-Rot 49 | Scarlet GN | E 125 |
| 15510 | C-ext. Orange 8 | Orange II, D&C Orange 4 | — |
| 15620 | C-WR Rot 13 | — | — |
| 15980 | C-Orange 9 | Orange GGN | E 111 |
| 15985 | C-Orange 10 | Yellow orange S, Sunset Yellow | E 110 |
| | | FCF, FD&C Yellow 6, L-Orange 2 | |
| 16035 | C-Rot 60 | Allura Red AC, FD&C Red 40 | — |
| 16185 | C-Rot 46 | Amaranth, L-Red 3 | E 123 |
| 16230 | C-ext. Orange 11 | Orange GG | — |
| 16255 | C-Rot 47 | Ponceau 4R, L-Red 4, Cochineal | E 124 |
| | | Red A | |
| 16290 | C-Rot 48 | Ponceau 6R | E 126 |
| 17200 | C-Rot 58 | Fast Acid Magenta B, D&C | — |
| | | Red 33 | |
| 18050 | C-ext. Rot 63 | Amido Naphthol Red G, Red 2G, | — |
| | | L-Red 12 | |
| 18130 | C-WR Rot 4 | Supranol Brilliant Red 3B | — |
| 18690 | C-WR Orange 9 | Zapon Fast Yellow R, Perm. Fast | — |
| | | Yellow G | |
| 18736 | C-WR Orange 8 | Palatine Fast Red RN | — |
| 18820 | C-WR Gelb 9 | Flavazin L | — |
| 18965 | — | Yellow 2G | — |
| 19140 | C-Gelb 10 | Tartrazine, FD&C Yellow 5, L- | E 102 |
| | | Yellow 2, Permanent Yellow NCG | |
| 20170 | C-ext. Braun 4 | Resorcinol Brown, D&C Brown 1 | — |
| 20470 | C-WR Schwarz 1 | Amido Black 10 B | — |
| 24790 | C-WR Red 18 | Supranol Red BR | — |
| 27290 | — | Brilliant Crocein MOO | — |
| 27755 | C-Schwarz 7 | Black 7984 | E 152 |
| 28440 | C-Schwarz 6 | Brilliant Black BN, Brilliant | E 151 |
| | | Black PN, L-Black 1 | |
| 40215 | C-WR Orange 1 | — | — |
| 42045 | C-ext. Blau 13 | Patent Blue VF | — |
| 42051 | C-Blau 20 | Patent Blue V, L-Blue 3 | E 131 |
| 42053 | C-Grün 12 | Fast Green FCF | — |
| 42080 | C-WR Blau 11 | Patent Blue A | — |
| 42090 | C-Blau 21 | Patent Blue AE, Brilliant Blue | — |
| | | FCF, FD&C Blue 1, L-Blue 4 | |
| 42100 | C-WR Grün 5 | — | — |
| 42170 | C-ext. Grün 10 | Alkali Fast Green 10 G, L-ext. | — |
| | | Green 2 | |
| 42510 | C-WER Violett 8 | Fuchsin, Magenta | — |
| 42520 | — | New Fuchsin, New Magenta | — |
| 42735 | C-ext. Blau 14 | Brilliant Wool Blue FFR | — |
| 44045 | C-WR Blau 8 | Victoria Blue B | — |
| 44090 | C-Grün 4 | Wool Green S, Brilliant Acid | E 142 |
| | | Green BS, L-Green 3 | |
| 45100 | — | Sulforhodamine B | — |
| 45190 | C-WR Violett 5 | Fast Acid Violet ARR, L-ext. | — |
| | | Violet 2 | |
| 45220 | C-WR Rot 16 | Sulforhodamine G | — |
| 45350 | C-ext. Gelb 16 | Fluorescein, Uranine, D&C Yellow | — |
| | | 7/8 | |
| 45380 | C-Rot 30 | Eosin, D&C Red 21/22 | — |
| 45430 | C-Rot 38 | Erythrosine, FD&C Red 3, | E 127 |
| | | L-Red 11 | |
| 47005 | C-Gelb 11 | Quinoline Yellow, L-Yellow 3 | E 104 |
| 50325 | C-WR Violett 10 | Wool Fast Violet B | — |
| 50420 | — | Nigrosin GF, water-soluble | — |
| 59040 | C-ext. Gelb 24 | Pyranine | — |
| 60730 | C-ext. Violett 21 | Anthranalan Violet 3B, Ext. D&C | — |
| | | Violet 2 | |
| 61570 | C-Grün 11 | Alizarin Cyanin G, D&C Green 5 | — |
| 61585 | C-WR Blau 10 | — | — |
| 73015 | C-Blau 19 | Indigotine, Indigo Carmine, FD&C | E 132 |
| | | Blue 2, L-Blue 2 | |
| 74180 | C-WR Blau 12 | Heliogen Blue SBL, Sirius Light | — |
| | | Turquoise GL | |
| 75815 | C-Grün 8 | Chlorophyllin/Cu complex | E 141 |
| — | C-Rot 53 | Beetroot Red | E 162 |
| — | C-Rot 52 | Anthocyans | E 163 |
| 11920 | C-Orange 1 | Sudan Orange G | — |
| 12150 | C-Rot 2 | Solvent Red 1, Food Red 16 | — |
| 12700 | — | Sudan Yellow 3G | — |
| 21230 | C-ext. Gelb 21 | Sudan Yellow GRN, L-ext. | — |
| | | Yellow 1 | |
| 26100 | C-ext. Rot 56 | Sudan Red BK, D&C Red 17 | — |
| 40800 | C-Orange 11 | β-Carotene, L-Orange 3 | E 160a |
| 40820 | C-Orange 16 | Apocarotenal, L-Orange 8 | E 160e |
| 40825 | C-Orange 17 | Apocarotenic acid ethyl ether, L- | E 160f |
| | | Orange 9 | |
| 40850 | C-Orange 15 | Canthaxanthin | E 161g |
| 45370 | C-Rot 27 | D&C Orange 5 | |
| 4700 | C-ext. Gelb 23 | Quinoline Yellow A, spirit | — |
| | | soluble, D&C Yellow 11 | |
| 56238 | C-WR Gelb 16 | Hostasol Yellow 3G | — |
| 61554 | — | Solvent Blue 35, Fat Blue B, | — |
| | | Sudan Blue II | |
| 61565 | C-Grün 10 | Alizarin Cyanin Green, fat | — |
| | | soluble, D&C Green 6 | |
| 60725 | C-ext. Violett 18 | Irisol, spirit soluble, D&C Violet 2 | — |
| 69800 | C-Blau 18 | Indanthrene Blue RS, Indanthrone | E 130 |
| 7300 | C-Blau 22 | Indigo, D&C Blue 6 | — |
| 75120 | C-Orange 12 | Annatto, Orlean, Bixin, Norbixin, | E 160b |
| | | L-Orange 4 | |
| 75125 | C-Orange 14 | Lycopene, L-Orange 6 | E 160d |
| 75130 | C-Orange 11 | Carotene, L-Orange 3 | E 160a |
| 75135 | C-Orange 15d | Xanthophylls, L-Orange 7d, | E 161d |
| | | Rubixanthin | |
| 75170 | — | Guanines | — |
| 75300 | C-Gelb 15 | Curcumin, Turmeric, L-Yellow 7 | E 100 |
| 75810 | C-Grün 8 | Chlorophyll/Cu complex, L- | E 140 |
| | | Green 2 | |
| — | C-Gelb 14 | Riboflavin, lactoflavin, vitamin | E 101 |
| | | B₂, L-Yellow 6 | |
| — | C-WER Grün 3 | Bromocresol Green | — |
| — | C-WR Blau 3 | Bromothymol Blue | — |
| | C-Orange 13 | Capsanthin, Capsorubin, L- | E 160c |
| | | Orange 5 | |
| — | — | Solvent Blue 97, Ceres Blue RR | — |

According to a preferred embodiment of the present invention, dyes which are preferably used are erythrosine (C.I. 45 430; E 127) and Ponceau 4R (C.I. 16255; E 124) and Curcumin (C.I. 75300; E 100), β-Carotene (C.I. 40800; E 160a), Riboflavin (E 101) and Ceres Blue RR.

### EXAMPLES

A test strip prepared according to the invention with three separately discernible adsorption areas Z, F and E is briefly dipped, including the adsorption areas, in water, which has been mixed with 0.1% alkylbenzenesulfonic acid (ABS) and 10% ethanol (for preservation and to improve wetting). The test strip is then dragged with the adsorption areas under gentle finger pressure for a distance of 10 cm over the surface to be tested. The test strip is then clamped into a device and the adsorption areas are sprayed with various reagents: area E is sprayed with a 2% solution of diphenylamine in 10% phosphoric acid; area F is sprayed with a 0.1% solution of dichloro-fluorescein in 96% ethanol and area Z is sprayed with a 0.5% solution of ninhydrin in 96% ethanol. In the presence of protein residues, a violet colour is observed in area E. In the next stage, area F is illuminated with a UV lamp (366 nm) and assessed. If fat residues are present, they may be identified as light yellow spots on a yellow/green background. The UV lamp is then switched off and the test strip heated over a heater. The test strip is heated to 150° C. for 5 minutes. A grey/violet colour in area Z reveals residues of carbohydrates.

If required, the qualitatively observed colours may also be quantified using appropriate measures to detect colour intensity.

1-12. (Cancelled).

13. A method for detecting the presence of at least two different residues on a hard surface comprising the following steps:
a providing an article;
b. providing at least one adsorbent on the article, the adsorbent having a chemical substance capable of reacting with the residues to form a visually discernible color;
c. contacting the adsorbent with the residues on a hard surface;
d. adsorbing the residues onto the adsorbent; and
e. forming a visually discernible color as a result of the reaction of the residues with the chemical substance.

14. The method of claim 13, wherein the visually discernable color is different for each type of residue.

15. The method of claim 13, wherein the contacting step requires manually contacting the adsorbent with the residues on a hard surface.

16. The method of claim 13, wherein the residues are selected from the group consisting of fat, protein, carbohydrate, and mixtures thereof.

17. The method of claim 13, further comprising the additional step of increasing the temperature of the article prior to the step of forming a visually discernible color.

18. The method of claim 13, wherein the chemical substance is selected from the group consisting of ninhydrin, Coomassie blue, Folin reagent, biuret reagent, a-naphthol, diphenylamine, aniline, iodine, lipase, fluorescent dyes, and mixtures thereof.

19. The method of claim 13, wherein the adsorbent is a solid polymeric material.

20. The method of claim 19, wherein the solid polymeric material is selected from the group consisting of wool, silk, polyacrylic, viscose, polyamide, polyacetate, and lyocell.

21. The method of claim 13, wherein the article includes a plurality of adsorbents.

22. The method of claim 21, wherein the plurality of adsorbents are the same adsorbent.

23. The method of claim 21, wherein the plurality of adsorbents are different adsorbents.

24. The method of claim 21, wherein the plurality of adsorbents are located in different areas of the article.

25. The method of claim 13, comprising the additional step of moistening the adsorbent before contacting the adsorbent with the residues on a hard surface.

26. A method for detecting the presence of at least two different residues on a hard surface comprising the following steps:
a providing an article;
b. providing at least one adsorbent on the article;
c. contacting the adsorbent with the residues on a hard surface;
d. adsorbing the residues onto the adsorbent;
e. applying to the adsorbent a chemical substance capable of reacting with the residues to form a visually discernible color; and
f. forming a visually discernible color as a result of the reaction of the residues with the chemical substance.

27. The method of claim 26, wherein the visually discernable color is different for each type of residue.

28. The method of claim 26, wherein the contacting step requires manually contacting the adsorbent with the residues on a hard surface.

29. The method of claim 26, wherein the residues are selected from the group consisting of fat, protein, carbohydrate, and mixtures thereof.

30. The method of claim 26, further comprising the additional step of increasing the temperature of the article prior to the step of forming a visually discernible color.

31. The method of claim 26, wherein the chemical substance is selected from the group consisting of ninhydrin, Coomassie blue, Folin reagent, biuret reagent, a-naphthol, diphenylamine, aniline, iodine, lipase, fluorescent dyes, and mixtures thereof.

32. The method of claim 26, wherein the adsorbent is a solid polymeric material.

33. The method of claim 26, wherein the solid polymeric material is selected from the group consisting of wool, silk, polyacrylic, viscose, polyamide, polyacetate, and lyocell.

34. The method of claim 26, wherein the article includes a plurality of adsorbents.

35. The method of claim 34, wherein the plurality of adsorbents are the same adsorbent.

36. The method of claim 34, wherein the plurality of adsorbents are different adsorbents.

37. The method of claim 34, wherein the plurality of adsorbents are located in different areas of the article.

38. The method of claim 26, comprising the additional step of moistening the adsorbent before contacting the adsorbent with the residues on a hard surface.

39. A system for detecting the presence of at least two different residues on a hard surface, the system comprising:
a. at least two different residues, wherein the residues are selected from the group consisting of a fat, protein, carbohydrate, and mixtures thereof;
b. an article; and
c. at least one adsorbent located on the article, wherein the adsorbent has a chemical substance capable of reacting with the residues to form a visually discernable color, and the chemical substance is selected from the group consisting of ninhydrin, Coomassie blue, Folin reagent, biuret reagent, a-naphthol, diphenylamine, aniline, iodine, lipase, fluorescent dyes, and mixtures thereof.

40. The system of claim 39, wherein the visually discernable color is different for each residue.

41. The system of claim 39, wherein the adsorbent is a solid polymeric material.

42. The system of claim 41, wherein the solid polymeric material is selected from the group consisting of wool, silk, polyacrylic, viscose, polyamide, polyacetate, and lyocell.

43. The system of claim 39, wherein the article includes a plurality of adsorbents.

44. The system of claim 43, wherein the plurality of adsorbents are the same adsorbent.

45. The system of claim 43, wherein the plurality of adsorbents are different adsorbents.

46. The system of claim 43, wherein the plurality of adsorbents are located in different areas of the article.
